(19) United States
(12) Patent Application Publication
(10) Pub. No.: US 2012/0311605 A1
(43) Pub. Date: Dec. 6, 2012

(54) PROCESSOR CORE POWER MANAGEMENT TAKING INTO ACCOUNT THREAD LOCK CONTENTION

(75) Inventors: Bret R. Olszewski, Austin, TX (US); Basu Vaidyanathan, Austin, TX (US)

(73) Assignee: INTERNATIONAL BUSINESS MACHINES CORPORATION, Armonk, NY (US)

(21) Appl. No.: 13/149,492

(22) Filed: May 31, 2011

(51) Int. Cl. G06F 9/46

(52) U.S. Cl. 718/107

(57) ABSTRACT

A method maintains, for each processing element in a processor, a count of threads waiting in a data structure for hand-off locks in order to execute on the processing element. The method maintains the processing element in a first power state if the count of threads waiting for hand-off locks is greater than zero. The method puts the processing element in a second power state if the count of threads waiting for hand-off locks is equal to zero and no thread is ready to be processed by the processing element. The method returns the processing element to the first power state if the count of threads becomes greater than zero, or if a thread becomes ready to be processed by the processing element.

### BACKGROUND

The present invention relates generally to the field of processor core power management, and more particularly to methods, systems, and computer program products that manage processor core power while accounting for thread lock contention.

A thread of execution is the smallest unit of processing that can be scheduled by an operating system. Threads are parts of processes and multiple threads in a process share resources, such as memory. Multithreading, which allows multiple threads of a process to be executed concurrently, can greatly increase computing speed and efficiency. However, since the threads of a process share the same memory, certain threads must execute before other threads.

Concurrency of thread execution is maintained through the use of locks. Locks are provided to protect critical sections of execution. When one thread holds a lock and another thread attempts to gain access to a processing element, the thread attempting the access must not be allowed to proceed until thread holding the lock is processed and the lock is given to the thread attempting access.

Currently, there are a number of lock mechanisms. In systems using busy wait locks, threads waiting on locks spin until the lock becomes free. In systems using blind dispatch locks, threads waiting on locks are undispatched and redispatched at a later time. In systems using hand-off locks, the operating system uses data structures to keep track of threads waiting on locks and wakes them in an ordered fashion.

Power management allows processors to reduce their power consumption, usually at the expense of performance. A core on a microprocessor may have its voltage and/or frequency reduced to reduce power consumption. The core may additionally be put into a very low power mode where it executes no instructions, but waits for an event to revert to normal operation. The very low power state may be referred to as napping.

In the case of heavy contention on hand-off locks, it will be common that a number of software threads will be waiting for a lock to execute on a processor core. Since threads waiting on locks cannot execute, it is likely that, with enough contention, entire cores could be put to napping while sleeping threads wait to be processed on the core. It is also typical that optimization for memory affinity will put a premium on keeping threads executing where their memory is allocated. This would tend to keep the operating system from moving threads that are waiting on napping cores to more active cores.

When heavy lock contention on a hand-off lock occurs, the rate of process on the lock is paced by:
1. The time to wake up the thread;
2. The time to acquire the lock, do critical section processing, and release the lock; and,
3. The time to identify the next thread to gain the lock and awaken it.
   In the case of serious contention on a hand-off lock, the speed at which the waiters can be processed paces the progress against the length of the queue. Conditions that increase the latency to process elements of the queue retard the general performance, response times, and throughput of the workload.

Typically, power management is tightly tied to the busyness of a core. For example, if there are four hardware threads on a core and at least one thread is running a software thread, the core cannot be placed into a very low power state, where thread progress is essentially stopped, or reduced to a crawl. However, if no threads are active on the core, it can be placed into a very low power state and awakened when needed. There is typically a definable latency to transition a core from the very low power state to normal operation. This latency can be quite large in terms of processor cycles.

This interplay of hand-off locks with power management creates an unusual and problematic side-effect. Threads waiting on hand-off locks are essentially idle, which can trigger power management. However, the actual speed of handing off locks can be paced by the latency to transition cores out of power management. If the core on which the thread to be awakened is napping, the latency to wake the thread may be greatly increased, resulting in far worse convoy performance to hand-off the lock. This will result in cases where the entire workload throughput on a system may be reduced to a crawl while threads convoy through a lock slowly.

### BRIEF SUMMARY

Embodiments of the present invention provide methods, systems, and computer program products for processing element power management while taking into account lock contention. In one embodiment, method maintains, for each processing element in a processor, a count of threads waiting in a data structure for hand-off locks in order to execute on the processing element. The method maintains the processing element in a first power state if the count of threads waiting for hand-off locks is greater than zero. The method puts the processing element in a second power state if the count of threads waiting for hand-off locks is equal to zero and no thread is ready to be processed by the processing element. The method returns the processing element to the first power state if the count of threads becomes greater than zero, or if a thread becomes ready to be processed by the processing element.

The method increments the count of threads when a thread waiting for a hand-off lock is added to the data structure for the processing element. The method decrements the count of threads when a thread waiting for a hand-off lock is removed from the data structure for the processing element. A processing element may comprise a processor core.

### BRIEF DESCRIPTION OF THE SEVERAL VIEWS OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of an embodiment of a system according to the present invention;

FIG. 2 is a flowchart of an embodiment of sleeping thread processing;

FIG. 3 is a flowchart of an embodiment of maintaining a count of sleeping thread processing according to the present invention;

FIG. 4 is a flowchart of an embodiment of core power management according to the present invention; and,

FIG. 5 is a block diagram of a computing device in which features of the present invention may be implemented.

### DETAILED DESCRIPTION

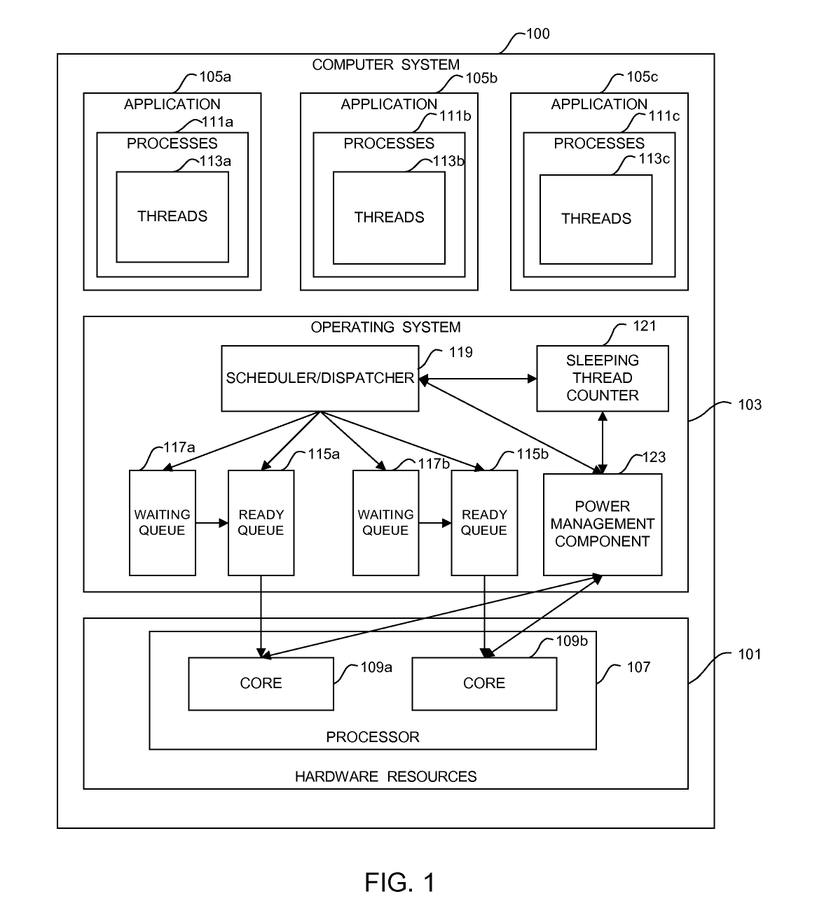

Referring now to the drawings, and first to FIG. 1, a computer system is designated generally by the numeral 100. Computer system 100 includes hardware resources, designated generally by the number 101, an operating system, designated generally by the numeral 103, and one or more applications 105. Hardware resources 101 include, among other components, at least one processor 107. Processor 107 includes multiple execution cores 109. Each application 105 includes multiple processes 111. Each process 111 includes multiple execution threads 113.

Operating system 103 includes multiple data structures or queues that hold execution threads 113 to be processed by processor 107. More specifically, operating system 103 includes, for each core 109, a ready queue 115, which holds threads ready to be processed on its associated core 109. Thus, threads in ready queue 115a are processed on core 109a; threads in ready queue 115b are processed on core 109b. Each ready queue has associated therewith a waiting queue 117, which holds threads that are not ready to be processed on a core 109.

Threads held in waiting queues 117 include threads that are waiting for hand-off locks. Hand-off locks are a mechanism for maintaining concurrency by protecting critical threads of execution. A thread that must execute before another holds a lock. The other thread or threads cannot execute until the lock is released and given to the next thread to be processed. Threads waiting for hand-off locks may be referred to as sleeping threads.

A scheduler/dispatcher 119 manages queues 115 and 117. When scheduler/dispatcher 119 sends a thread holding a hand-off lock to a core 109 and core 109 processes that thread, scheduler/dispatcher 119 wakes the next sleeping thread waiting for the lock in a waiting queue 117, gives the lock to the awakened thread, and moves the awakened thread with the lock from waiting queue 117 to associated ready queue 115.

According to the present invention, a sleeping thread counter 121 maintains a count of sleeping threads in the waiting queue 117 associated with each core 109. As will be described in detail hereinafter, a power management component 123 of operating system 103 uses the sleeping thread counts maintained by sleeping thread counter 121 together with the contents of the ready queues 115 to control the power state of each core 109.

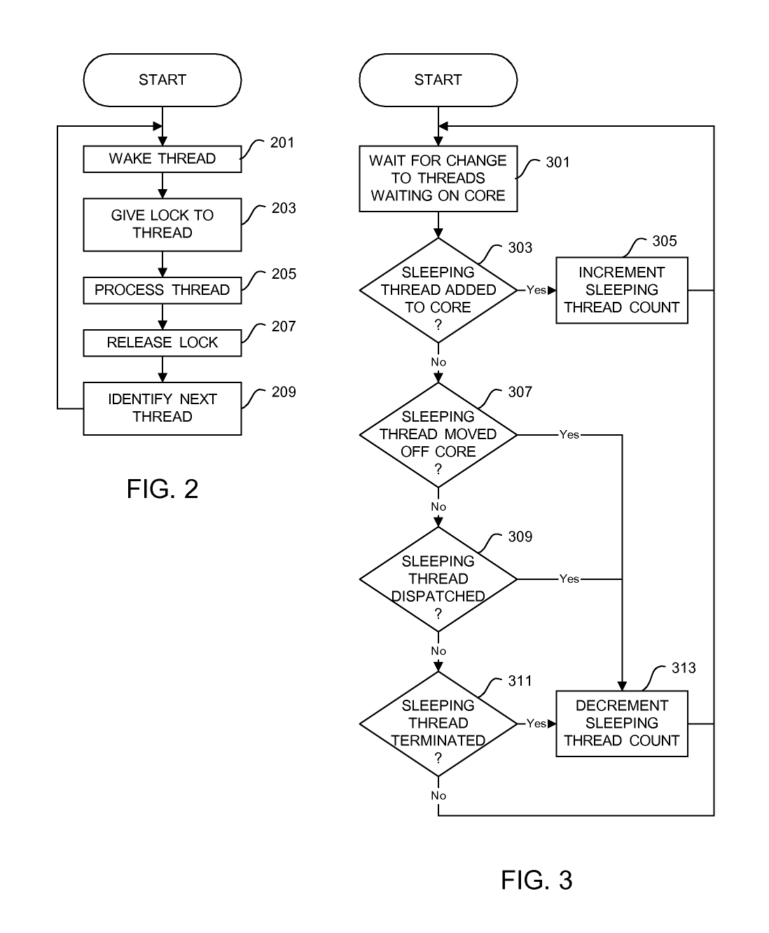

FIG. 2 is a flowchart of sleeping thread processing. Scheduler/dispatcher 119 wakes a thread, at block 201. Scheduler/dispatcher 119 gives the hand-off lock to the thread, at block 203. Then scheduler/dispatcher 119 sends the thread to be processed on a core 109, at block 205. When the core 109 finishes processing the thread, scheduler/dispatcher 119 releases the lock, at block 207, and determines the next sleeping thread to be processed, at block 209. Then, scheduler/dispatcher 119 returns to block 201 to wake the next thread.

FIG. 3 is a flowchart of an embodiment of sleeping thread counter 121 processing according to the present invention. Sleeping thread counter 121 maintains a separate count of sleeping threads waiting for each core 109. Sleeping thread counter 121 waits for changes in threads waiting on each core 109, at block 301. If, as determined at decision block 303, scheduler/dispatcher 119 adds a sleeping thread to a core 109, sleeping thread counter 121 increments the sleeping thread count for that core, at block 305. If, as determined at decision block 307, scheduler/dispatcher moves a sleeping thread off the core to another, sleeping thread counter 121 decrements the sleeping thread count for the core, at block 313. It will be noted, in the case of a move, sleeping thread counter 121 will increment the sleeping thread count for the core to which the sleeping thread is moved. If, as determined at decision block 309, sleeping thread counter 121 dispatches a sleeping core to a ready queue for processing on the core, sleeping thread counter 121 decrements the sleeping thread count for the core, at block 313. Finally, if, as determined at decision block 311, a sleeping thread is terminated, sleeping thread counter 121 sleeping thread counter 121 decrements the sleeping thread count for the core, at block 313.

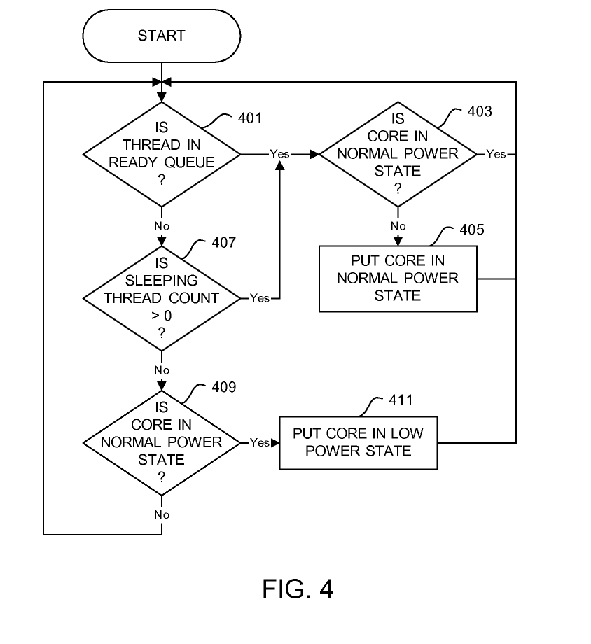

FIG. 4 is a flowchart of an embodiment of power management component 123 processing according to the present invention. Power management component 123 continuously monitors, for each core 109, the count of sleeping threads maintained for the core by sleeping thread counter 121 and the contents of the ready queue 115 associated with the core. Power management component 123 determines, at decision block 401, if there is a thread in the ready queue for the core. If there is a thread in the ready queue for the core, power management component 123 determines, at decision block 403, if the core is in its normal power state. If the core is not in its normal power state, power management component 123 puts the core in its normal power state, at block 405. If the core is already in the normal power state, the core remains in the normal power state.

Returning to decision block 401, if power management component 123 determines there is no thread in the ready queue for the core, power management component 123 determines, at decision block 407, if the sleeping thread count for the core is greater than zero. If the sleeping thread count is greater than zero, power management component 113 determines, at decision block 403, if the core is in its normal power state. If the core is not in its normal power state, power management component 123 puts the core in its normal power state, at block 405. If the core is already in the normal power state, the core remains in the normal power state. If, as determined at decision block 407, the sleeping thread count for the core is not greater than zero, power management component 123 determines, at decision block 409, if the core is in the normal power state. If the core is in the normal power state, power management component 123 puts the core in a low power state, at block 411. If the core is already in a low power state, the core remains in the low power state.

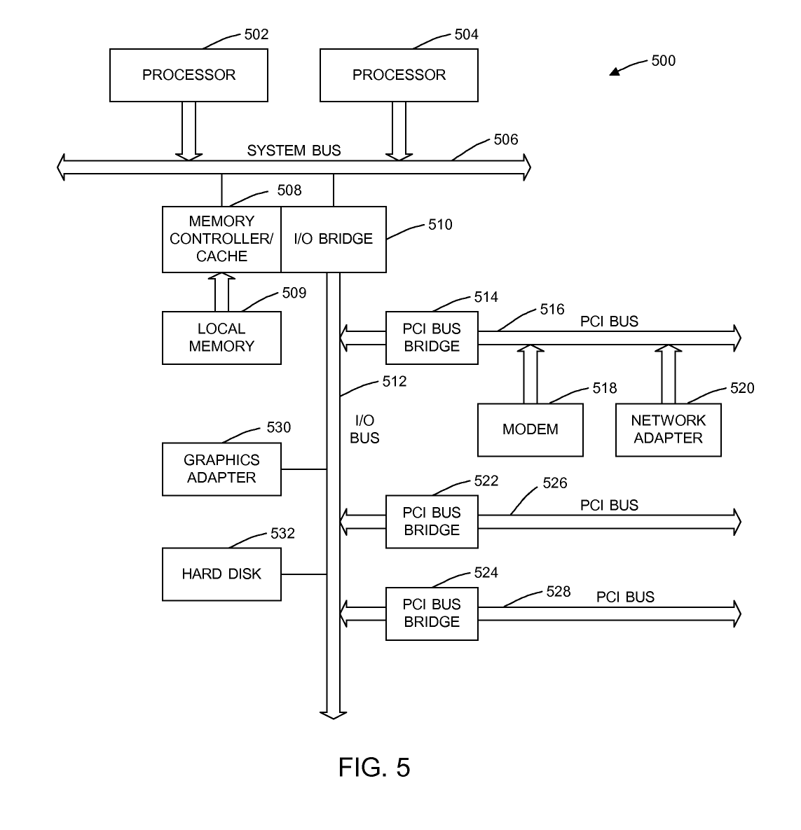

FIG. 5 is a block diagram of a data processing system upon which embodiments of the present invention may be implemented. Data processing system 500 may be a symmetric multiprocessor (SMP) system including a plurality of processors 502 and 504 connected to system bus 506. Alternatively, a single processor system may be employed. Also connected to system bus 506 is memory controller/cache 508, which provides an interface to local memory 509. I/O bus bridge 510 is connected to system bus 506 and provides an interface to I/O bus 512. Memory controller/cache 508 and I/O bus bridge 510 may be integrated as depicted.

Peripheral component interconnect (PCI) bus bridge 514 connected to I/O bus 512 provides an interface to PCI local bus 516. A number of modems may be connected to PCI local bus 516. Typical PCI bus implementations will support four PCI expansion slots or add-in connectors. Communications links to networks may be provided through a modem 518 or a network adapter 520 connected to PCI local bus 516 through add-in boards. Additional PCI bus bridges 522 and 524 provide interfaces for additional PCI local buses 526 and 528, respectively, from which additional modems or network adapters may be supported. In this manner, data processing system 500 allows connections to multiple network computers. A memory-mapped graphics adapter 530 and hard disk 532 may also be connected to I/O bus 512 as depicted, either directly or indirectly.

Those of ordinary skill in the art will appreciate that the hardware depicted in FIG. 5 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 5 may be, for example, an IBM® eServer™ pSeries system, a product of International Business Machines Corporation in Armonk, N.Y., running the Advanced Interactive Executive (AIX™) operating system or LINUX operating system.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium or media having computer readable program code embodied thereon.

Any combination of one or more computer readable medium or media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc.. or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The computer program instructions comprising the program code for carrying out aspects of the present invention may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the foregoing flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the foregoing flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

From the foregoing, it will be apparent to those skilled in the art that systems and methods according to the present invention are well adapted to overcome the shortcomings of the prior art. While the present invention has been described with reference to presently preferred embodiments, those skilled in the art, given the benefit of the foregoing description, will recognize alternative embodiments. Accordingly, the foregoing description is intended for purposes of illustration and not of limitation.

What is claimed is:

1. A method, which comprises:
maintaining, for each processing element in a processor, a count of threads waiting in a data structure for hand-off locks in order to execute on said processing element; and,
maintaining said processing element in a first power state if said count of threads is greater than zero.

2. The method as claimed in claim 1, including putting said processing element in a second power state if said count of threads is equal to zero and no thread is ready to be processed by said processing element.

3. The method as claimed in claim 2, including returning said processing element to said first power state if said count of threads becomes greater than zero.

4. The method as claimed in claim 2, including returning said processing element to said first power state if a thread becomes ready to be processed by said processing element.

5. The method as claimed in claim 1, wherein said maintaining said count of threads includes incrementing said count of threads when a thread waiting for a hand-off lock is added to said data structure for said processing element.

6. The method as claimed in claim 1, wherein said maintaining said count of threads includes decrementing said count of threads when a thread waiting for a hand-off lock is removed from said data structure for said processing element.

7. The method as claimed in claim 1, wherein said processing element comprises a processor core.

8. A system, which comprises:
a data structure in a multi-processing element computer system for containing, for each processing element of said computer system, threads waiting for hand-off locks in order to execute on a processing element;
a counter for maintaining a count of threads waiting for hand-off locks in said data structure in order to execute on said processing element; and,
a power control component arranged to maintain said processing element in a first power state if said count of threads in said data structure is greater than zero.

9. The system as claimed in claim 8, wherein said power control component is further arranged to put said processing element into a second power state if said count of threads is equal to zero and no thread is ready to be processed by said processing element.

10. The system as claimed in claim 9, wherein said power control component is further arranged to return said processing element to said first power state if said count of threads becomes greater than zero.

11. The system as claimed in claim 9, wherein said power control component is further arranged to return said processing element to said first power state if a thread becomes ready to be processed by said processing element.

12. The system as claimed in claim 8, wherein said counter is arranged to increment said count when a thread waiting for a hand-off lock is added to said data structure.

13. The system as claimed in claim 8, wherein said counter is arranged to decrement said count when a thread waiting for a hand-off lock is removed from said data structure.

14. The method as claimed in claim 8, wherein said processing element comprises a processor core.

15. A computer program product in computer readable storage medium, said computer program product comprising:
instructions stored in said computer readable storage medium for maintaining, for each processing element in a processor, a count of threads waiting in a data structure for hand-off locks in order to execute on said processing element; and,
instructions stored in said computer readable storage medium for maintaining said processing element in a first power state if said count of threads is greater than zero.

16. The computer program product as claimed in claim 15, further comprising instructions stored in said computer readable storage medium for putting said processing element into a second power state if said count of threads is equal to zero and no thread is ready to be processed by said processing element.

17. The computer program product as claimed in claim 16, further comprising instructions stored in said computer readable storage medium for returning said processing element to said first power state if said count of threads becomes greater than zero.

18. The computer program product as claimed in claim 16, further comprising instructions stored in said computer readable storage medium for returning said processing element to said first power state if a thread becomes ready to be processed by said processing element.

19. The computer program product as claimed in claim 15, wherein said maintaining said count of threads includes incrementing said count of threads when a thread waiting for a hand-off lock is added to said data structure for said processing element.

20. The computer program product as claimed in claim 15, wherein said maintaining said count of threads includes decrementing said count of threads when a thread waiting for a hand-off lock is removed from said data structure for said processing element.
